(19) United States
(12) Patent Application Publication
(10) Pub. No.: US 2007/0151426 A1
(43) Pub. Date: Jul. 5, 2007

(54) HEX WRENCH

(76) Inventor: Tzu-Chi Kuo, Keelung (TW)

Correspondence Address: PAI PATENT & TRADEMARK LAW FIRM, 1001 FOURTH AVENUE, SUITE 3200, SEATTLE, WA, 98154, US

(21) Appl. No.: 11/306,553

(22) Filed: Jan. 2, 2006

(51) Int. Cl. B25B 15/00; B25B 13/48; B25B 23/00

(52) U.S. Cl. 81/177.1; 81/436; 16/421

(57) ABSTRACT

A hex wrench includes a wrench body, which has a handle, a head, a bent portion connected between the handle and the head, a handle work tip at the free end of the handle, and a head work tip at the free end of the head, a long hexagonal plastic sleeve tightly wrapped about the handle, and a short hexagonal plastic sleeve tightly wrapped about the head.

### BACKGROUND OF THE INVENTION

(a) Field of the Invention

The present invention relates to hex wrenches and more particularly to a hex wrench which has anti-slip sleeves wrapped about the handle and the head.

(b) Description of the Prior Art

A regular hex wrench is a hexagonal angle bar having a handle at one end and a head at the other end. The handle and the head each have the respective free end terminating in a work tip. By means of the work tip, the hex wrench can be operated to turn, for example, a socket head bolt.

Because a hex wrench has a hexagonal outside wall, the user's hand receives much reactive force from the angles of the hexagonal outside wall of the hex wrench when turning the workpiece, causing the hand to ache. A person who needs to use a hex wrench frequently, for example, a car repair mechanic or assembly line worker, usually has calluses on the hands.

### SUMMARY OF THE INVENTION

The present invention has been accomplished under the circumstances in view. It is the main object of the present invention to provide a hex wrench which has anti-slip sleeves wrapped about the handle and the head for protection.

According to the present invention, the hex wrench comprises a wrench body, which comprises a handle, a head, a bent portion connected between the handle and the head, a handle work tip at one end of the handle remote from the bent portion, and a head work tip at one end of the head remote from the bent portion, wherein the handle is covered with a long plastic sleeve, which has a hexagonal inside wall fitting tightly the periphery of the handle and a hexagonal outside wall for gripping by the user; the head is covered with a short plastic sleeve, which has a hexagonal inside wall fitting tightly the periphery of the head and a hexagonal outside wall for gripping by the user.

### BRIEF DESCRIPTION OF THE DRAWINGS

FIG. 1 is an exploded view of a hex wrench according to the present invention.

FIG. 2 is a perspective view of the assembled hex wrench according to the present invention.

FIG. 3 is a front view of the hex wrench according to the present invention.

FIG. 4, corresponding to FIG. 3, shows an alternate form of the short plastic sleeve.

FIG. 5 is a cross sectional view of the present invention.

FIG. 6 is an exploded view showing another alternate form of the long plastic sleeve and the short plastic sleeve according to the present invention.

### DETAILED DESCRIPTION OF THE PREFERRED EMBODIMENTS

Referring to the annexed drawings in detail, a hex wrench in accordance with the present invention is shown comprising an angled wrench body 1, a long plastic sleeve 2, and at least one short plastic sleeve 3.

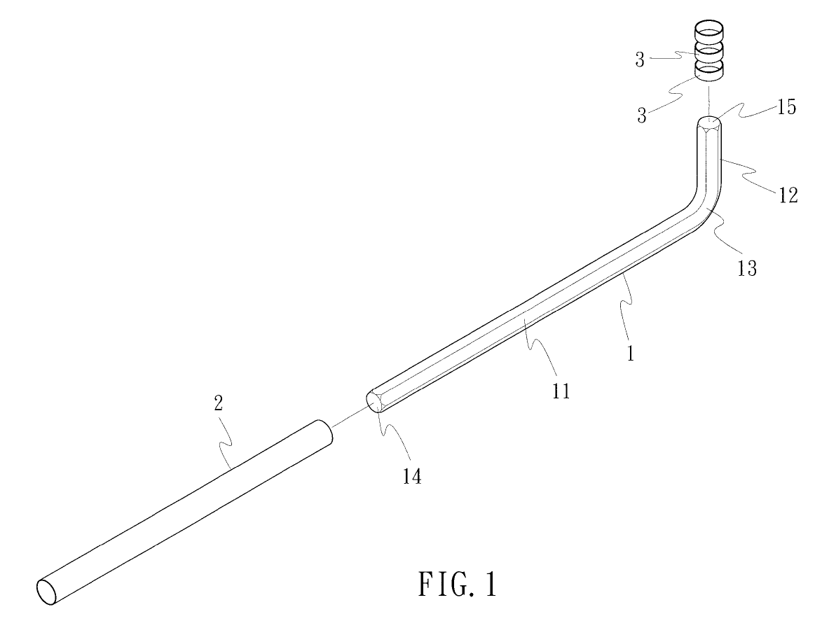

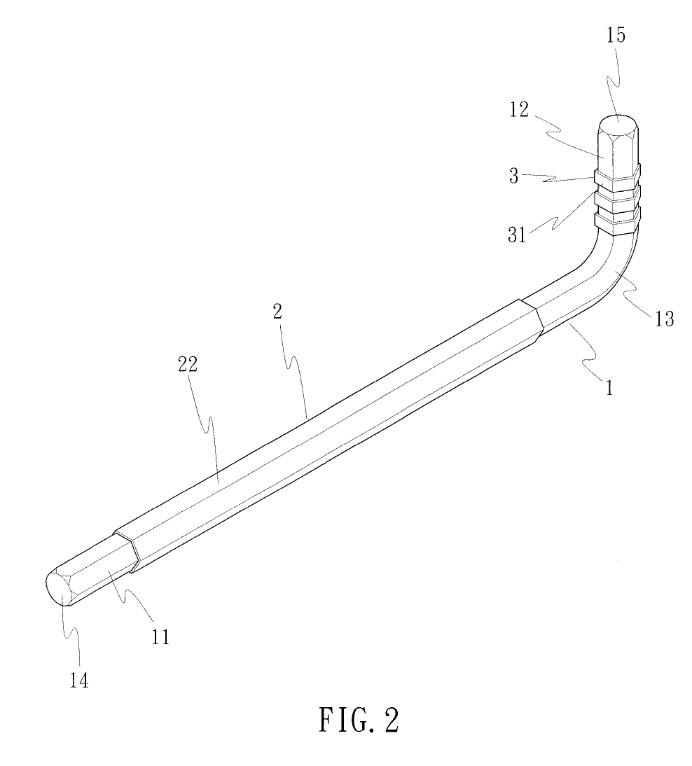

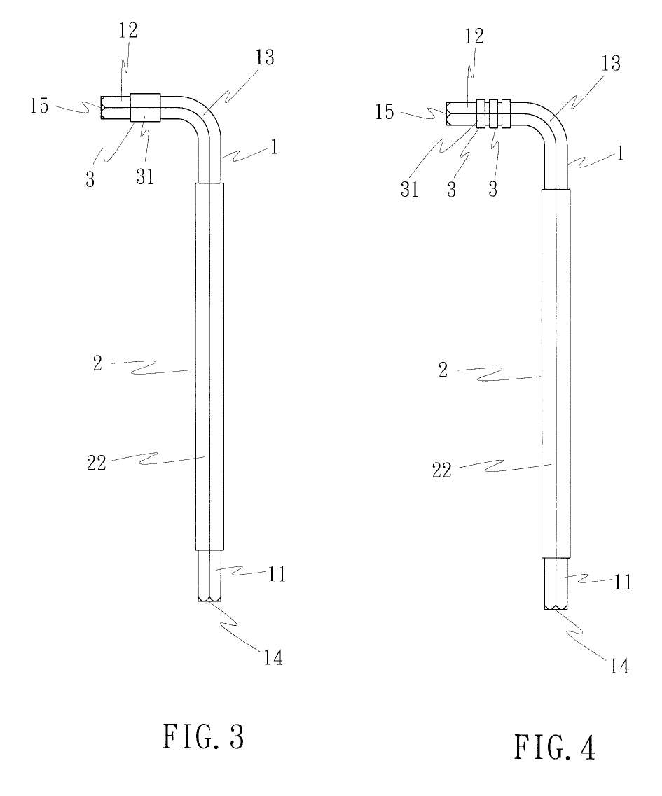

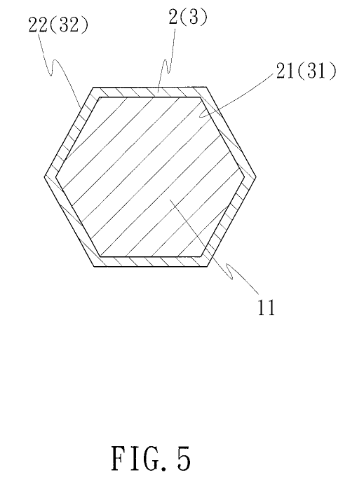

Referring to FIG. 1, the angled wrench body 1 is an angled hexagonal bar comprising a handle 11, a head 12, a bent portion 13 connected between the handle 11 and the head 12. The head 12 has one end connected to the bent portion 13 and the other end terminating in a head work tip 15. The handle 12 has one end connected to the bent portion 13 and the other end terminating in a handle work tip 14. By means of the work tip 14 or 15, the angled wrench body 1 can be operated to turn a socket head bolt.

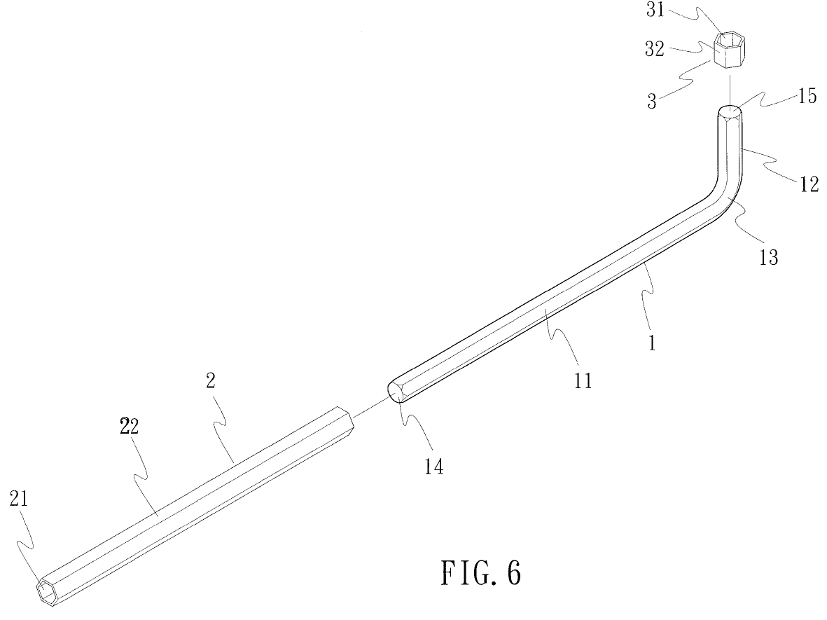

Referring to FIGS. 1˜5, the long plastic sleeve 2, which has a hexagonal inside wall 21 and a hexagonal outside wall 22, is sleeved onto the handle 11 of the angled wrench body 1 and set between the bent portion 13 and the handle work tip 14 of the handle 11, i.e., the handle work tip 14 of the handle 11 is exposed to the outside of the long plastic sleeve 2. The hexagonal inside wall 21 fits the hexagonal outside wall of the handle 11. The long plastic sleeve 2 can be a flexible circular plastic tube (see FIG. 1), which is forced to expand when sleeved onto the handle 11, thereby forming the hexagonal inside wall 21 and the hexagonal outside wall 22. Alternatively, the long plastic sleeve 2 can be a thermal shrinkage plastic tube sleeved onto the handle 11 and then heated to shrink, forming the hexagonal inside wall 21 and the hexagonal outside wall 22. The long plastic sleeve 2 can also be directly molded from plastics having the desired hexagonal inside wall 21 and hexagonal outside wall 22 before mounting (see FIG. 6).

Referring to FIGS. 1˜4, the at least one short plastic sleeve 3 is respectively sleeved onto the head 12 of the wrench body 1 and set between the bent portion 13 and the head work tip 15 of the head 12, i.e., the head work tip 15 of the head 12 is exposed to the outside of the at least one short plastic sleeve 3. Each short plastic sleeve 3 has a hexagonal inside wall 31 and a hexagonal outside wall 32. The hexagonal inside wall 31 fits the hexagonal outside wall of the head 12. Further, each short plastic sleeve 3 can be made in the same manner as the aforesaid long plastic sleeve 2. Further, the short plastic sleeve 3 can be colored with a particular color or marked with a sign, indicating the size of the hex wrench.

The plastic sleeves 2 and 3 give a soft touch. When the user holds the plastic sleeve 2 or 3 to operate the hex wrench, the plastic sleeve 2 or 3 absorbs the reactive force from the angles of the hexagonal outside wall of the wrench body 1. Therefore, the user can operate the hex wrench comfortably. Further, when operating the hex wrench to turn a socket head bolt in a cold weather, the user's hand does not feel so cold because the user does not touch the metal wrench body directly. Further, because the plastic sleeves 2 and 3 have a hexagonal outside wall 21 or 31 for gripping, the user can hold the hex wrench tightly in hand when turning the workpiece.

Although a particular embodiment of the invention has been described in detail for purposes of illustration, various modifications and enhancements may be made without departing from the spirit and scope of the invention.

What is claimed is:

1. A hex wrench comprising a wrench body, said wrench body having a handle having a hexagonal periphery, a head having a hexagonal periphery, a bent portion connected between one end of said handle and one end of said head, a handle work tip at one end of said handle remote from said bent portion, and a head work tip at one end of said head remote from said bent portion, wherein said handle is covered with a long plastic sleeve, said long plastic sleeve having a hexagonal inside wall fitting tightly the hexagonal periphery of said handle and a hexagonal outside wall for gripping by a user.

2. The hex wrench as claimed in claim 1, wherein said head is covered with at least one short plastic sleeve, said at least one short plastic sleeve each having a hexagonal inside wall fitting tightly the hexagonal periphery of said head and a hexagonal outside wall for gripping by a user.

3. The hex wrench as claimed in claim 1, wherein said long plastic sleeve is formed of a round plastic tube, which is sleeved onto said handle by force and forced to expand by said handle after being sleeved onto said handle, thereby forming the hexagonal inside wall and the hexagonal outside wall of said handle.

4. The hex wrench as claimed in claim 1, wherein said long plastic sleeve is a round thermal shrinkage plastic tube, which is sleeved onto said handle and then heated to shrink, thereby forming the hexagonal inside wall and the hexagonal outside wall of said handle.

5. The hex wrench as claimed in claim 1, wherein said long plastic sleeve is directly formed of a hexagonal plastic tube having a hexagonal inside wall and a hexagonal outside wall.

6. The hex wrench as claimed in claim 2, wherein said at least one short plastic tube each have an outside wall marked with a sign.
